(19) United States
(12) Patent Application Publication
(10) Pub. No.: US 2002/0019829 A1
(43) Pub. Date: Feb. 14, 2002

(54) Community co-presence system and method having virtual groups

(76) Inventor: Ehud Shapiro, Nataf (IL)

Correspondence Address: HALE & DORR LLP, THE WILLARD OFFICE BUILDING, 1455 PENNSYLVANIA AVE, NW, WASHINGTON, DC, 20004, US

(21) Appl. No.: 09/813,324

(22) Filed: Mar. 21, 2001

Related U.S. Application Data
(60) Provisional application No. 60/190,937, filed on Mar. 21, 2000.

(51) Int. Cl. G06F 17/30; G06F 15/16

(52) U.S. Cl. 707/201; 707/10; 707/8; 709/204; 345/753

(57) ABSTRACT

A method of establishing communication with a community of users is described. The method includes the steps of receiving geographical location information of a first user belonging to the community of users and determining a geographical region in which the first user is located based on the geographical location information. The method also includes the step of finding other users from the community of users who are located within the geographical region. Corresponding system, medium and means are also described.

### FIELD OF THE INVENTION

The present invention relates generally to a communication system serving user defined communities, and more particularly, to a system, method, and computer readable medium storing computer-executable instructions arranging communications with members belonging to a community based on proximity detection and/or predetermined common characteristics.

### BACKGROUND OF THE INVENTION

It is known in the art to provide data retrieval systems with a co-presence mechanism in which two or more users, who retrieve the same data object at the same time, can become aware of each other and consequently to communicate with each other in real time.

An example of the co-presence mechanism (also discussed in U.S. Pat. No. 5,819,084 issued to Shapiro et al. and U.S. Pat. No. 5,864,874 issued to Shapiro, which are incorporated herein by reference in their entirety) is shown in FIGS. 1 and 2 which illustrate a community co-presence server. In particular, FIG. 1 shows two community co-presence servers 50A and SOB, four co-presence data retrieval clients 52A, 52B, 52C and 53D, and four data servers 54A, 54B, 54C and 54D. Each community server 50 provides a community of co-presence users, through clients 52, all of whom are accessing data. Those users of one community looking at one piece of data, such as a web page, will be co-present with each other. However, those users of another community (who might, for example, be from another internet service provider) will not be co-present with the users of the first community. They will be co-present only with the users from their own community.

More specifically, clients 52A and 52B are associated with server 50A (see solid lines 51A and S1B) and clients 52C and 52D are associated with server 50B (solid lines 51C and 51D). When client 52A accesses a data object, labeled 56, in data server 54B, as indicated by dashed line 53A, community server 50A creates a virtual place 58 which is associated with data object 56 and to which client 52A is joined (dotted line 55A). When client 52B, also associated with community server 50A, accesses data object 56 (dashed line 53B), it will be joined (dotted line 55B) to virtual place 58 and will be co-present with client 52A already there. Thus, clients 52A and 52B see the same data object, know that each other is present at the data object and can converse with each other, either about the data object or about something else.

However, when client 52C accesses data object 56, as indicated by dashed line 53C, it will not be joined to virtual place 58 since that place belongs to community server 50A and client 52C belongs to community server 50B. Instead, community server SOB creates its own virtual place, labeled 60, associated with data object 56 and joins client 52C to it (as marked by dotted line 61A). When client 52D accesses data object 56, as indicated by dashed line 53D, community server 50B joins client 52D to virtual place 60 (as indicated by dotted line 61B) where client 52D will be co-present with client 52C.

The procedure for providing community co-presence is illustrated in FIG. 2. First, a user 70, through his “client” computer 52, becomes part of the community, typically by registering at the community co-presence server 50. This step is labeled step 71 and involves maintaining a list of users forming part of the community. In the second step (labeled 72), the user 70 accesses a data object, such data object 56, at a data server 54. In step 73, the data server 54 provides the data 56 to the client 52. In step 74, the client 52 sends a message to the virtual place 58 within the community co-presence server 50 which is associated with the data object 56 to the effect that user 70 has accessed the data object 56. The virtual place 58 then adds user 70 to the list of users present thereat. Finally, in step 75, community co-presence server 50 sends a message that client 52 has just accessed data object 56 to all of the other clients 52 listed in the list of users of virtual place 58.

I have determined, however, that the above described conventional community based communication systems, however, cannot determine if two members of a community are physically located close to each other to arrange for a person to person meeting. I have also determined that the conventional systems are incapable of indicating its members which other members, if any, are located in physical proximity to each other, based on predetermined criteria for arranging such a meeting.

### SUMMARY OF THE INVENTION

Embodiments of the present invention advantageously overcomes the shortcomings of the conventional systems, among other advantages. In particular, embodiments of the present invention are directed to a mobile communication system and/or method for informing an individual, who is using the system, whether there are other individuals of the same community who are using the system that are in physical proximity to said individual, and enable said individual to establish communication with such other individuals. A method, system, medium and means of establishing communication with a community of users defining a predetermined characteristic that users have in common.

One of the methods of the present invention includes the steps of receiving geographical location information of a first user belonging to the community of users, determining a geographical region in which the first user is located based on the geographical location information, and finding other users from the community of users who are located within the geographical region.

In embodiments of the present invention, the method may also include the step of notifying identities of the other users found within the geographical region to the first user. An alternative embodiment includes the step of notifying identity of the first user to the other users found within the geographical region. In yet some other embodiments, the method may include the step of notifying identities of the first user and the other users found within the geographical region to each other. Furthermore, in other embodiments, the method may also include the step of receiving the geographical location information from a Global Positioning System (GPS) device. Other embodiments may also include the step of receiving the geographical location information from a device configured to communicate its geographical location and voice/data information. In another embodiment, the received geographical location of the first user can be related to future scheduled location of the first user. Moreover, in this embodiment, the geographical location of the other users of the community of users can be related to future scheduled location of the first user.

Embodiments of the present invention implemented in the medium, system and means include substantially identical features of the method embodiment of the present invention discussed above. For instance, at least some embodiments of the present may be implemented in a computer readable medium including instructions being executed by a computer. The instructions instructing the computer to create and use a computer-implemented embodiments of the present invention. The instructions comprising implementation of the steps of receiving geographical location information of a first user belonging to the community of users, determining a geographical region in which the first user is located based on the geographical location information, and finding other users from the community of users who are located within the geographical region. In another example, at least some embodiments of the present may be implemented in a system establishing communication with a community of users. The system include a computer having at least one central processing unit (CPU), a computer memory and/or storage, residing within said computer, and a co-presence server, residing at least in part within said computer memory and/or storage. The co-presence server is configured to receive geographical location information of a first user belonging to the community of users, determine a geographical region in which the first user is located based on the geographical location information, and find other users from the community of users who are located within the geographical region.

Embodiments of the present invention also includes a communication method that includes the step of associating a co-presence server with a community of members. The community defines at least one common, predetermined characteristic of the members. The method also includes the steps of creating at least one virtual group of the community and defining a predefined rule with which to determine whether the members belong to the at least one virtual group. The predetermined rule relates to geographical locations of the members or relates to time availability of the members. The method may also include the steps of determining whether or not a first member is belongs to the at least one virtual group based on the geographical location of the first member or time availability of the first member, identifying other members of community who also belong to the at least one virtual group, and notifying identities of the identified members to the first member. In addition, the method may also include the step of notifying identity of the first member to the identified members, or receiving the geographical locations from a device configured to communicate its geographical location and voice/data information.

Embodiments of the present invention may also include a communication system. The system includes a means for associating a co-presence server with a community of members. The community defines at least one common, predetermined characteristic of the members. The system may also include a means for creating at least one virtual group of the community, and a means for defining a predefined rule with which to determine whether the members belong to the at least one virtual group, wherein the predetermined rule relates to geographical locations of the members or relates to time availability of the members. In addition, the system can also include a means for determining whether or not a first member is belongs to the at least one virtual group based on the geographical location of the first member or time availability of the first member, a means for identifying other members of community who also belong to the at least one virtual group, and a means for notifying identities of the identified members to the first member. The system may also include a means for notifying identity of the first member to the identified members or a means for receiving the geographical locations from a device configured to communicate its geographical location and voice/data information.

Embodiments of the present invention may also include a communication system that includes a data server for retrieving at least a plurality of data objects from a data repository, means for generating one virtual place per data object retrieved from said data server and for associating each virtual place with its data object once its data object is accessed, and means for providing each virtual place with co-presence for at least two users that access the retrieved data object associated with each virtual place. The system may also include means for determining whether on not the at least two user belong to a virtual place among the virtual places based on geographical location of the at least two users, and means responsive to said co-presence at said virtual place, for placing said at least two users that access said retrieved data object associated with said virtual place in communication with each other. Furthermore, the system can include a co-presence server comprising at least one virtual place, and at least two co-presence data-retrieval clients for communicating at least with said data server and with said co-presence server, each including object association means for associating a data object received from said data server with one of said at least one virtual places in said co-presence server. The co-presence server comprises a changing plurality of place processes, one for each virtual place, and a managing process for providing communication from said co-presence data retrieval clients to said place processes. The object association means comprises means for moving to a new virtual place. The means for generating comprises a co-presence server comprising at least one virtual place which communicates with said data server, and at least two co-presence data-retrieval clients for communicating with said co-presence server, each including object association means for associating a data object received from said co-presence server with one of said at least one virtual places in said co-presence server. The co-presence server comprises a changing plurality of place processes, one for each virtual place, and a managing process for providing communication from said co-presence data retrieval clients to said place processes. The object association means comprises means for moving to a new virtual place.

Embodiments of the present invention may also include a communication system that includes a data server for retrieving at least a plurality of data objects from a data repository, means for generating one communication object place per data object retrieved from said data server and for associating each communication object with its data object once its data object is accessed, and means for providing each virtual place with co-presence for at least two users that access the retrieved data object associated with each virtual place. This system may also include means for determining whether on not the at least two user belong to a virtual place among the virtual places based on geographical location of the at least two users, and means responsive to said co-presence at said virtual place, for placing said at least two users that access said retrieved data object associated with said communication object in communication with each other.

Embodiments of the present invention also can include a data retrieval system that includes a data server for retrieving at least one of a plurality of data objects from a data repository, a co-presence server, and at least two co-presence data-retrieval clients for communicating at least with said data server and with said co-presence server. The co-presence server comprises community means for at least maintaining a list of co-presence data retrieval clients associated with a community, at least one virtual place having a list of co-presence data-retrieval clients from said community, means for determining whether on not the data-retrieval clients of the list belong to the at least one virtual place based on geographical location of the at least two users, and at said virtual place at least for enabling communication among said co-presence data-retrieval clients associated therewith. Each of the co-presence data retrieval clients may include object association means for associating a data object received from said data server with one of said at least one virtual places in said co-presence server, and co-presence means, associated with said one virtual place, for associating said client with said community and for enabling communication among said co-presence data-retrieval clients associated with said one virtual place. The community means also comprises finding means for providing a first co-presence data retrieval client of a first virtual place with a second virtual place with which a second co-presence data retrieval client is associated and communication means for providing a communication channel between said first and second virtual places to enable communication between said first and second co-presence data retrieval clients. The co-presence server comprises a changing plurality of place processes, one for each virtual place, and a managing process for providing communication from said co-presence data retrieval clients to said place processes. The object association means comprises means for moving to a new virtual place.

### BRIEF DESCRIPTION OF THE DRAWINGS

The detailed description of embodiments of the present invention showing various distinctive features may be best understood when the detailed description is read in reference to the appended drawing in which:

FIG. 1 is a schematic illustration of a prior art community co-presence system;

FIG. 2 is a schematic illustration of a prior art co-present data retrieval operation within the system of FIG. 1;

FIG. 3 is a block diagram of an overall system of embodiments of the present invention;

FIG. 3A is a diagram illustrating an exemplary Global System for Mobile Communication (GSM) that may be used to implement mobile co-presence unit according to embodiments of the present invention;

FIG. 4 is a flow chart illustrating an exemplary protocol using a registration from a mobile phone in accordance with embodiments of the present invention;

FIG. 5 is a flow chart illustrating an exemplary protocol using a phone call from a mobile phone in accordance with embodiments of the present invention;

FIG. 6 is a flow chart illustrating an exemplary protocol using a user notification from a mobile phone in accordance with embodiments of the present invention;

FIG. 7 is a flow chart illustrating an exemplary protocol using a regular notification feature of a mobile phone in accordance with embodiments of the present invention;

FIG. 8 is a flow chart of a graphical user interface for a user in accordance with embodiments of the present invention;

FIG. 9 is a flow chart of an exemplary rule (e.g., based on geographical location) in accordance with embodiments of the present invention;

FIG. 10 is a flow chart of another exemplary rule (e.g., based on schedules of members) in accordance with embodiments of the present invention;

FIG. 11A is a block diagram illustrating an exemplary cellular phone system that may be used to implement embodiments of the present invention;

FIG. 11 is a block diagram illustrating an example of a combined Internet, POTS, and ADSL architecture which may be used to implement embodiments of the present invention;

FIG. 12 is a block diagram illustrating one example of a central processing unit for implementing a computer process in accordance with a computer implemented embodiment of the present invention;

FIG. 13 is a block diagram of a computer system that includes a server according to embodiments of the present invention; and

FIG. 14 is a diagram illustrating a floppy disk that may store various portions of the software according to embodiments of the present invention.

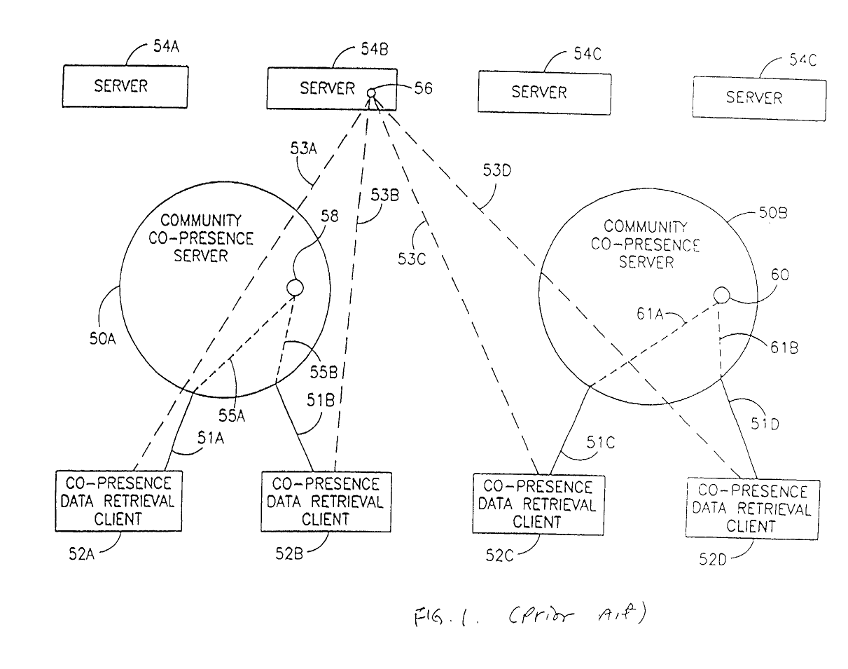

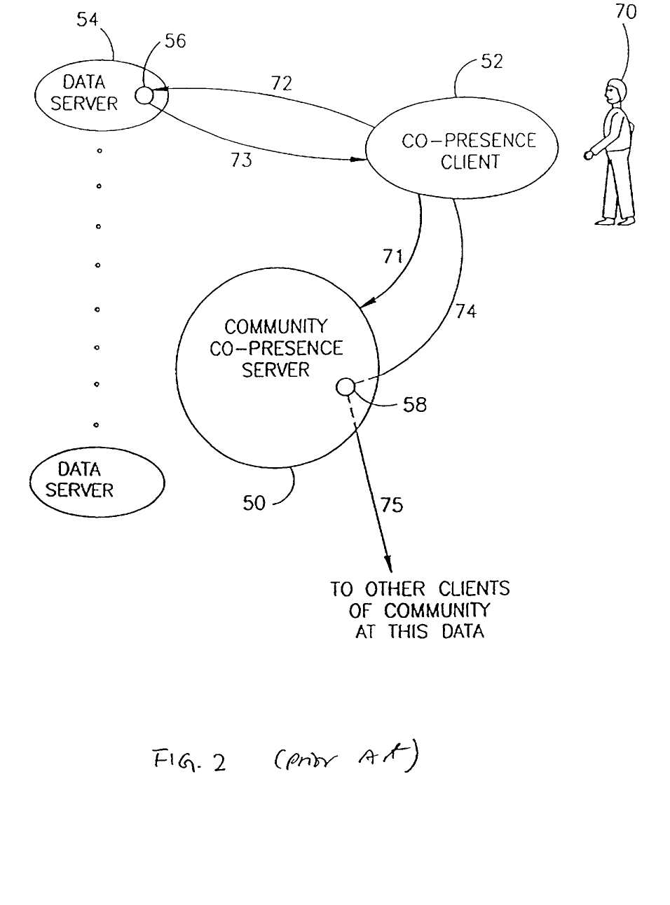

### DETAILED DESCRIPTION OF THE INVENTION

Reference now will be made in detail to embodiments of the present invention. Such embodiments are provided by way of explanation of the invention, which is not intended to be limited thereto. In fact, those of ordinary skill in the art may appreciate upon reading the present specification and viewing the present drawings that various modifications and variations can be made thereto.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

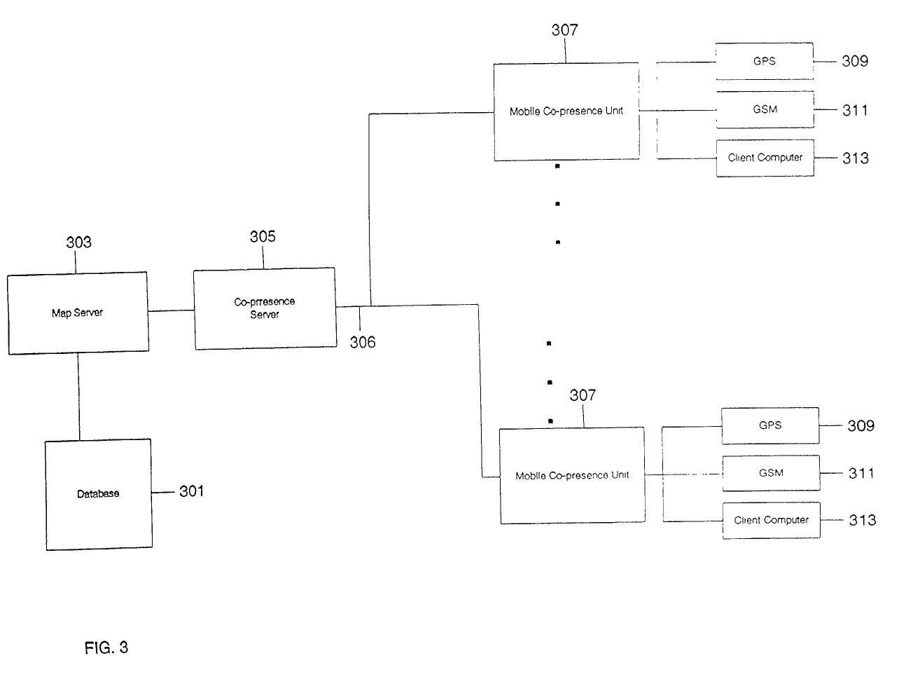

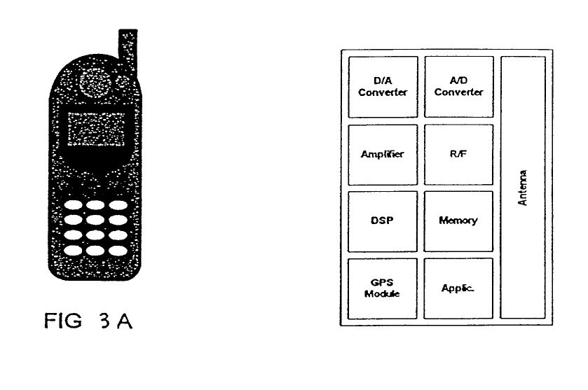

In accordance with the principles of the present invention, one embodiment of the present invention includes various components illustrated in FIG. 3. As shown in FIG. 3, the various components of the present invention include a database 301, a map server 303, a co-presence server 305, and a number of mobile co-presence units 307. Database 301 can be implemented using any standard database management system, e.g., ORACLE™ developed and manufactured by Oracle Corporation of Redwood Shores, Calif. Map server 303 can be a server providing information relating to maps (e.g., distances between two mobile co-presence units). Co-presence server 305 provides various services to its mobile co-presence units 306. More specifically, co-presence server 305 is connected to a number of mobile co-presence units 307 via a communication link 306. It should be noted that more than one co-presence server 305 is optionally used. Communication link 306 can be the Internet, wireless/wire telecommunication links, or the like provided by a telephone service network.

Mobile co-presence unit 307 preferably includes one or a combination of the following: a standard Global Positioning System (GPS) device 309, a standard Global System for Mobile Communication device (GSM) 311, and a client computer 313 configured to run client programs. A GSM is a combination of a cellular or wireless phone and a GPS device. For instance, NavTalk™, developed and manufactured by Garmin of Olathe, Kans., includes a high-performance cellular phone with features such as a touch-tone location reporting feature that sends its user's location using its internal GPS unit. Another example of GSM is Neotracker™, developed and manufactured by NeoPoint, Inc., of San Diego, Calif. Mobile co-presence unit 307 can be carried by a person or can be attached to cars, boats, planes, robots, toys, cargo, briefcase or the like.

More specifically, FIG. 3A depicts an exemplary GSM 311 for use in accordance with the principles of the present invention. As illustrated in FIG. 3A, the exemplary GSM 311 includes standard cellular phone features such as a D/A converter, amplifier, Digital Signal Processor (DSP), Applications, Memory, Radio Frequency (R/F) component, A/D converter and an antenna. In addition, the exemplary GSM 311 includes a GPS module. The exemplary GSM 311 is configured to transmit geographical location information (from the GPS module) to co-presence server 305.

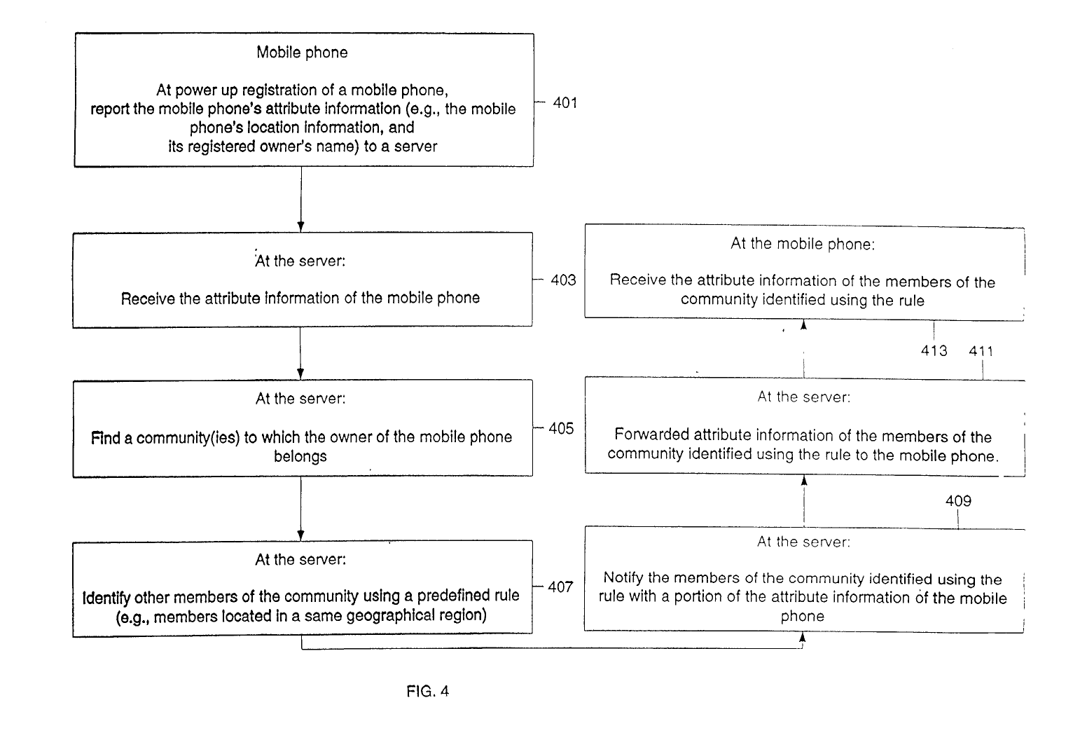

Various operations (e.g., protocols) of the components described above are described in detail in connection with FIGS. 4-7 and in connection with GSM 311. It should be appreciated, however, that the following descriptions provide the basis with which to use client computer 313 or GPS 309 with the embodiments described in FIGS. 4-7.

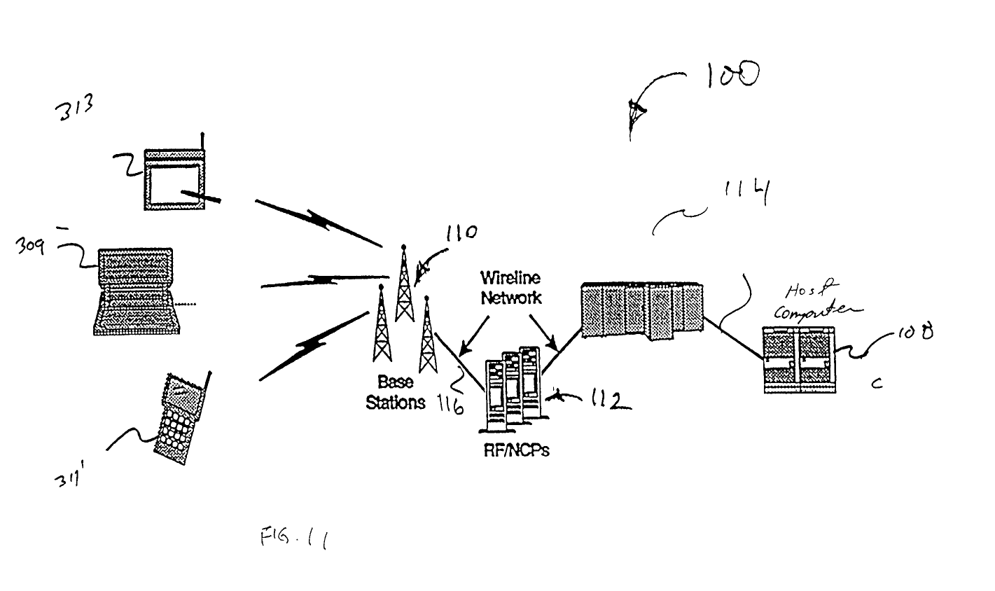

Now referring to FIG. 4, in step 401, a caller located at GSM 311 powers up a mobile phone which causes GSM 311 to register with its telephone or network service provider. The operation of the telephone or network service provider is described later in connection with FIG. 11. In turn, the telephone or network service provider notifies co-presence server 305 that the caller has registered. It should be noted that GSM 311 may also be configured to notify co-presence server 305 directly. In another embodiment, the telephone or network service provider and GSM 311 may notify co-presence server 305 independent from each other. Regardless which device notifies co-presence server 305, the notification is accompanied by attribute information. The attribute information may include the phone number of GSM 311, the name of the owner of GSM 311, the e-mail address of the owner of GSM 311, etc. Basically, the attribute information is any piece of information that can uniquely identify the owner of GSM 311 (hereinafter presumed to be the caller).

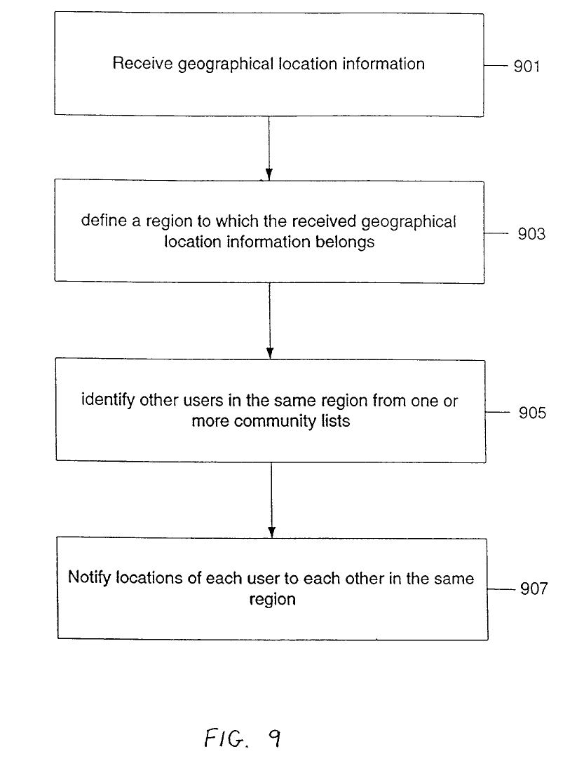

In one exemplary embodiment, the telephone or network service provider and/or GSM 311 is/are also configured to include geographical location information (the “location information”) of the caller when notifying co-presence server 305. This embodiment is referred as a “virtual place” embodiment hereinafter. The virtual place embodiment will be described by making references to FIG. 9. It should be noted that the following descriptions are directed to both embodiments of the present invention and to the virtual place embodiment. Accordingly, the descriptions are prefaced to designate which one of the embodiments is being described (e.g., either FIG. 4 or FIG. 9).

Now referring to FIG. 4, in step 403, co-presence server 305 is configured to receive the attribute information (and the location information in case of the virtual place embodiment) from either the telephone or network service provider or GSM 311 (or both). Once the attribute information is received, co-presence server 305 attempts to determine if the caller belongs to its community, based upon the attribute information (in step 405). In alternate embodiments of the present invention, one co-presence server 305 includes only one community. However, in yet other alternate embodiments of the present invention, one co-presence server 305 may include more than one community.

If the caller belongs to its community, then co-presence server 305 processes the next step of the protocol. If the caller does not belong to its community, it then, optionally, notifies other co-presence servers serving other communities and ensures that the notification of the caller is directed to the community(ies) to which the caller belongs. In an alternative embodiment of the present invention, the caller may belong to more than one community.

Communities preferably include members with similar hobbies and/or interests as defined by the respective members of the communities. Further, exemplary communities may be formed by the last names of the respective members. Yet more examples of communities may be formed among friends, colleagues, associations, companies, etc. Other exemplary communities may be formed by military organizations, rescue organizations, emergency organizations, etc. It should be noted that these examples of communities are a non-exhaustive list of communities. Hence, any arbitrary communities may be formed by any arbitrary number of members having common accepted characteristics.

Expanding the above described member characteristics, these characteristics can be physical characteristics and/or behavioral characteristics (e.g., favorite Web sites, type of music, etc.) that can be defined by the member and/or a third party (e.g., Internet Service Providers). These characteristics can be stored in database 301 and/or co-presence server 305 to be used globally or in local devices such as GSM 311 and/or client computer 313.

In order to describe the next step of the protocol, one of the characteristics of co-presence server 305 is described first. In particular, co-presence server 305 creates one or more virtual groups and maintains them. A virtual group is a group of members of a community formed by a rule. One example of the rule uses geographical location of the members to form groups. Another example of the rule uses schedules of the members to form groups.

In the virtual place embodiment, the virtual groups are referred as virtual places. Co-presence server 305 also includes a map of an area of interest (a small portion of the map that included in map server 303). An area of interest may be divided into regions, e.g., a building, a floor, a campus, or other definable areas, such that the members of the community within in a region may arrange for a person to person meeting within the region. For instance, when one of the members is in a building, he/she may conveniently arrange a meeting with another member of the community present in the same building. It should be noted that the regions can overlap with each other or can be mutually exclusive of each other, or combination thereof.

Defining a region can be achieved by using a distance from the user or a radius from the user. Another way to define a region is using the boundaries of a city, town, state, country, or park. Yet another way of defining a region is using the boundaries of a city block, within a building, within a floor, within an office. These are non-exhaustive ways in which to define a region. Other similar ways can be used in defining a region.

A virtual space is created when a member of the community notifies co-presence server 305 with the location information. In the virtual place embodiment, the virtual space created may center around the location of the first member to create a new region.

Alternatively, the entire map stored in map server 303 is subdivided into a number of regions. Such subdivisions would be stored in database 301. When a member notifies his/her location, co-presence server 305 initially determines whether the member's location belongs to any region already created and active. If so, the member is added to the virtual space. If not, then a new virtual space is selected from the database based on the location of the member. Subsequently, the new virtual space is created and active in co-presence server 305. It should be noted that when a new virtual space is created, the member may decide to delete such a virtual space and cause (e.g., send a request) the virtual space be removed from co-presence server 305.

Now turning to describe the embodiments of the present invention in connection with step 405, co-presence server 305 determines whether or not the caller belongs to one of the virtual groups created in and maintained by co-presence server 305.

An example of such a step is described using the virtual place embodiment. In the virtual place embodiment, co-presence server 305, having a number of virtual places created and active therein, determines based on the location information whether the caller's location is within the region(s) of the virtual spaces. If the caller's location is within one or more regions of the virtual spaces, other members of the community located within those virtual spaces are identified (step 407). If the caller's location is not within any of the regions of the virtual spaced of co-presence server 305, a new virtual space having the region that includes the caller's location is created.

Now further describing embodiments of the present invention, other members of the communities belonging to the virtual groups that the caller belongs to are then identified (step 407). The identified members of the virtual groups are notified of the caller's attribute (step 409). This notification is in the form of an e-mail message, a pager message, a phone message or the like. In a preferred embodiment of the present invention, co-presence server 305 is configured to allow each of the members to exclude receiving such notification from a specified person or a group of persons, e.g., based on their characteristics. In such embodiments, if the caller is the person or one of the persons identified to be excluded, no message is forwarded to the identified members who wished not to receive messages from the caller.

Co-presence server 305 then sends attribute information of all identified members present in the one or more virtual groups (step 411). In an alternate embodiment of the present invention, co-presence server 305 is configured to receive screening messages back from the identified members notified of the presence of the caller. For instance, one or more members of the community may not wish to allow his/her presence known to the caller, e.g., based on the caller's characteristic. In such an instance, those members send a message to co-presence server 305 not to send any message to the caller.

The attribute information of the identified members is then forwarded to GSM 311. Co-presence server 305 can then, at the option of the caller and the identified members of the virtual places, make appointments to meet at a certain location (e.g., a restaurant, a conference room, etc.). In other embodiments of the present invention, co-presence server 305 is configured to establish an automatic conference call between the identified members and the caller based on the previously selected arrangements.

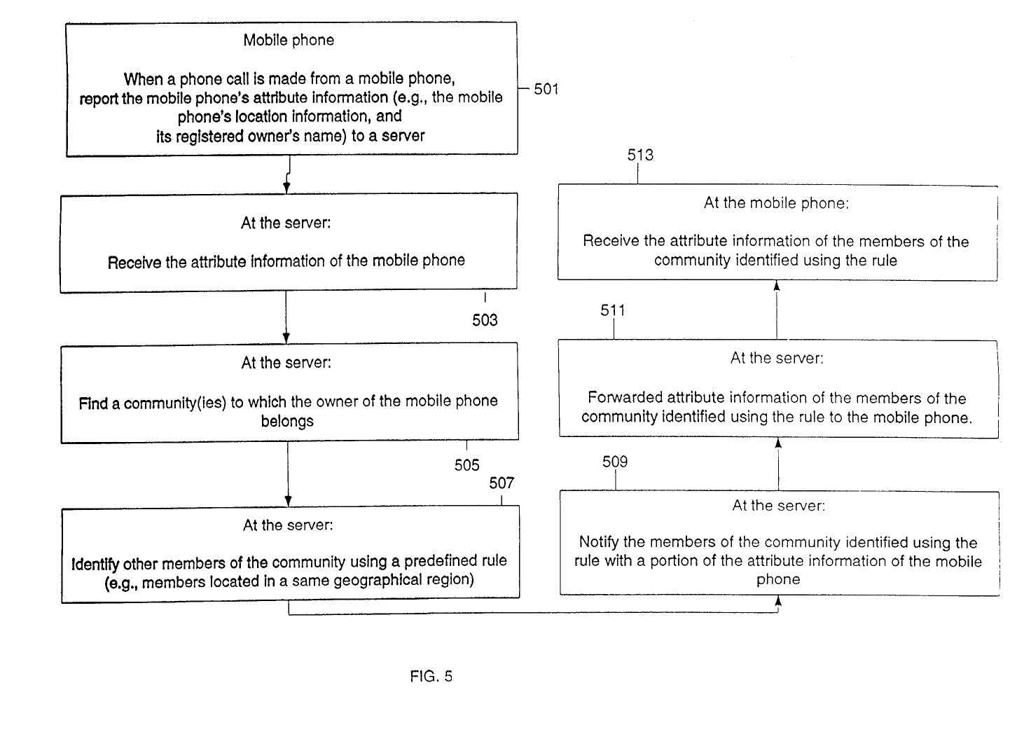

Now referring to FIG. 5, a caller located at GSM 311 makes a phone call using its telephone or network service provider. In turn, the telephone or network service provider notifies co-presence server 305 that the caller has made a phone call. It should be noted that GSM 311 may also be configured to notify co-presence server 305 directly. In another embodiment, the telephone or network service provider and GSM 311 may notify co-presence server 305 independent from each other. Regardless which device notifies co-presence server 305, the notification is accompanied by attribute information as described above in connection with FIG. 4. It should be noted that the descriptions provided above in connection with the virtual place embodiment apply to this embodiment as well.

In step 503, co-presence server 305 is configured to receive the attribute information (and the location information in case of the virtual place embodiment) from either the telephone or network service provider or GSM 311 (or both). Once the attribute information is received, co-presence server 305 attempts to determine if the caller belongs to its community, based upon the attribute information (in step 505). In an alternative embodiment of the present invention, one co-presence server 305 includes only one community. The above provided descriptions relating to alternative embodiments of having more than one communities and various definitions thereof and having more than one co-presence server also apply to this embodiment.

In order to describe the next step of the protocol, one of the characteristics of co-presence server 305 is described first. In particular, in an alternative embodiment of the present invention, co-presence server 305 creates one or more virtual groups and maintains them. In the virtual place embodiment, the virtual groups are referred as virtual places. The descriptions provided above relating to the virtual places in connection with FIG. 4 apply to this embodiment as well.

Now turning to describe the present invention in connection with step 507, co-presence server 305 determines whether or not the caller belongs to one of the virtual groups created in and maintained by co-presence server 305. Other members of the community that belong in the virtual groups are then identified (step 507). The identified members of the virtual groups are notified of the caller's attribute (step 509). This notification is in the form of an e-mail message, a pager message, a phone message or the like. In a preferred embodiment of the present invention, co-presence server 305 is configured to allow each of the members to exclude receiving such notification from a specified person or a group of persons, e.g., based on their characteristics. In such embodiments, if the caller is the person or one of the persons identified to be excluded, no message is forwarded to the identified members who wished not to receive messages from the caller. The example described above using the virtual space embodiment in connection with FIG. 4 is equally applicable to the present embodiment.

Co-presence server 305 then sends attribute information of all identified members present in the one or more virtual groups (step 511). Co-presence server 305 is optionally configured to receive screening messages back from the identified members notified of the presence of the caller, e.g., based on the caller's characteristic. For instance, one or more members of the community may not wish to allow his/her presence known to the caller. In such an instance, those members may send a message to co-presence server 305 not to send any message to the caller.

The attribute information of the identified members is then forwarded to GSM 311. Co-presence server 305 can then, at the option of the caller and/or the identified members of the virtual groups, can make appointments to meet at a certain location (e.g., a restaurant, a conference room, etc.). In other embodiments of the present invention, co-presence server 305 is configured to establish an automatic conference call between the identified members and the caller based on the previously selected arrangements.

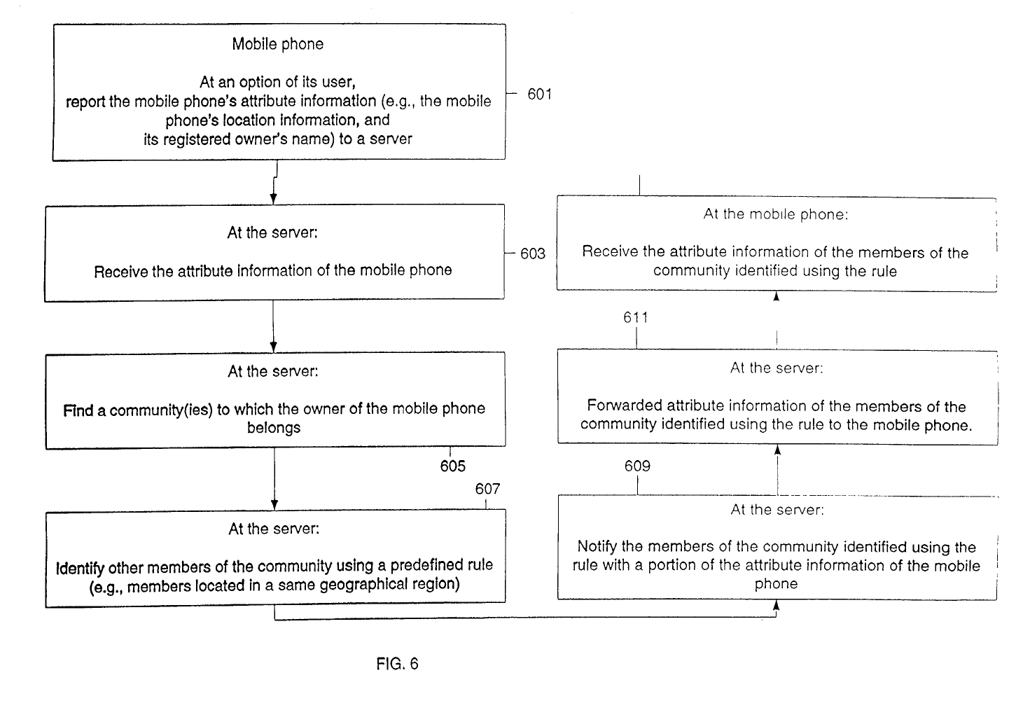

Now referring to FIG. 6, a caller located at one of GSM makes a request to its telephone or network service provider in order to notify co-presence server. In turn, the telephone or network service provider notifies co-presence server 305 that the caller has made a phone call. It should be noted that GSM 311 may also be configured to notify co-presence server 305 directly. In another embodiment, the telephone or network service provider and GSM 311 may notify co-presence server 305 independent from each other. Regardless which device notifies co-presence server 305, the notification is accompanied by attribute information as described above in connection with FIG. 4. It should be noted that the descriptions provided above in connection with the virtual place embodiment apply to this embodiment as well.

In step 603, co-presence server 305 is configured to receive the attribute information (and the location information in case of the virtual place embodiment) from either the telephone or network service provider or GSM 311 (or both). Once the attribute information is received, co-presence server 305 attempts to determine if the caller belongs to its community, based upon the attribute information (in step 605). In an alternative embodiment of the present invention, one co-presence server 305 includes only one community. The above provided descriptions relating to alternative embodiments of having more than one communities and various definitions thereof and having more than one co-presence server also apply to this embodiment.

In order to describe the next step of the protocol, one of the characteristics of co-presence server 305 is described first. In particular, in a preferred embodiment of the present invention, co-presence server 305 creates one or more virtual groups and maintains them. In the virtual place embodiment, the virtual groups are referred as virtual places. The descriptions provided above relating to the virtual places in connection with FIG. 4 apply to this embodiment as well.

Now turning to describe the embodiments of the present invention in connection with step 607, co-presence server 305 determines whether or not the caller belongs to one of the virtual groups created in and maintained by co-presence server 305. Other members of the community that belongs in the virtual groups are then identified (step 607). The identified members of the virtual groups are notified of the caller's attribute (step 609). This notification is in the form of an e-mail message, a pager message, a phone message or the like. In a preferred embodiment of the present invention, co-presence server 305 is configured to allow each of the members to exclude receiving such notification from a specified person or a group of persons, e.g., based on their characteristics. In such embodiments, if the caller is the person or one of the persons identified to be excluded, no message is forwarded to the identified members who wished not to receive messages from the caller. The example described above using the virtual space embodiment in connection with FIG. 4 is equally applicable to the present embodiment.

Co-presence server 305 then sends attribute information of all identified members present in the one or more virtual groups (step 611). In a preferred embodiment of the present invention, co-presence server 305 is configured to receive screening messages back from the identified members notified of the presence of the caller. For instance, one or more members of the community may not wish to allow his/her presence known to the caller, e.g., based on the caller's characteristic. In such an instance, those members may send a message to co-presence server 305 not to send any message to the caller.

The attribute information of the identified members is then forwarded to GSM 311. Co-presence server 305 can then, at the option of the caller and the identified members of the virtual groups, can make appointments to meet at a certain location (e.g., a restaurant, a conference room, etc.). In other embodiments of the present invention, co-presence server 305 is configured to establish an automatic conference call between the identified members and the caller based on the previously selected arrangements.

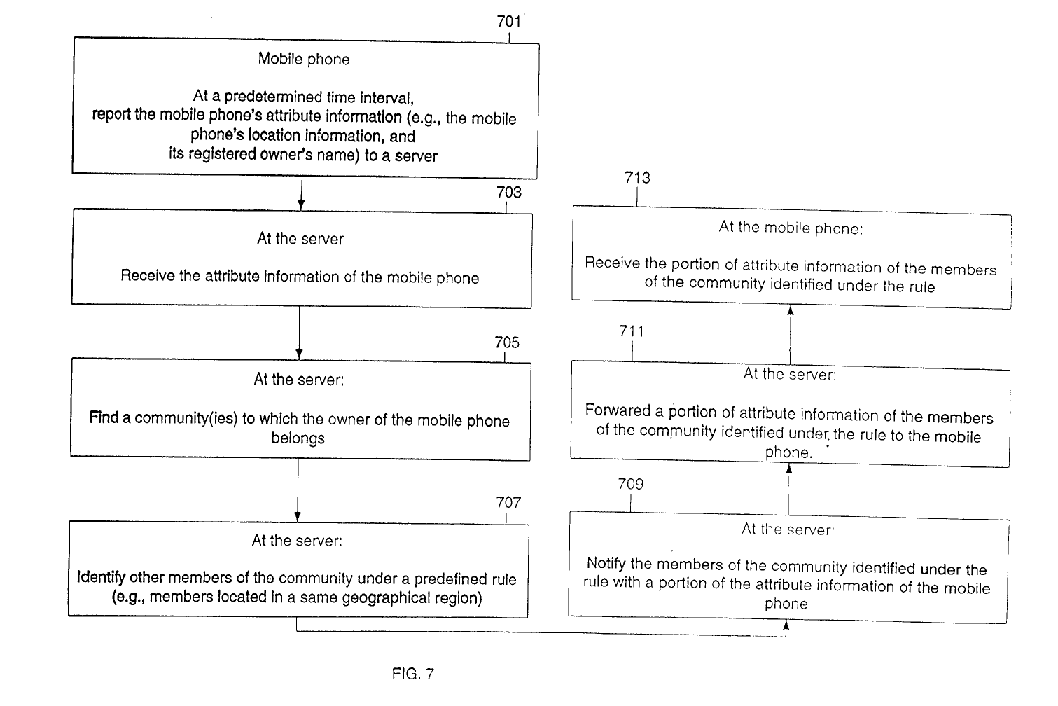

Now referring to FIG. 7, using client computer or GSM, a user of mobile co-presence unit 307 can configure client computer or GSM to make a request to the telephone or network service provider in order to notify co-presence server 305. The notification from one of the mobile co-presence units to its co-presence server is given at various times and/on various regular intervals. For example, a notification is transmitted on a regular interval, e.g., every hour, every day, or any other time intervals. In turn, the telephone or network service provider notifies co-presence server 305 that the caller has made a phone call. It should be noted that GSM 311 may also be configured to notify co-presence server 305 directly. In another embodiment, the telephone or network service provider and GSM 311 may notify co-presence server 305 independent from each other. Regardless which device notifies co-presence server 305, the notification is accompanied by attribute information as described above in connection with FIG. 4. It should be noted that the descriptions provided above in connection with the virtual place embodiment apply to this embodiment as well.

In step 703, co-presence server 305 is configured to receive the attribute information (and the location information in case of the virtual place embodiment) from either the telephone or network service provider or GSM 311 (or both). Once the attribute information is received, co-presence server 305 attempts to determine if the caller belongs to its community, based upon the attribute information (in step 705). In a preferred embodiment of the present invention, one co-presence server 305 includes only one community. The above provided descriptions relating to alternative embodiments of having more than one communities and various definitions thereof and having more than one co-presence server also apply to this embodiment.

In order to describe the next step of the protocol, one of the characteristics of co-presence server 305 is described first. In particular, in a preferred embodiment of the present invention, co-presence server 305 creates one or more virtual groups and maintains them. In the virtual place embodiment, the virtual groups are referred as virtual places. The descriptions provided above relating to the virtual places in connection with FIG. 4 apply to this embodiment as well.

Now turning to describe the embodiments of the present invention in connection with step 707, co-presence server 305 determines whether or not the caller belongs to one of the virtual groups created in and maintained by co-presence server 305. Other members of the community that belongs in the virtual groups are then identified (step 707). The identified members of the virtual groups are notified of the caller's attribute (step 709). This notification is in the form of an e-mail message, a pager message, a phone message or the like. In a preferred embodiment of the present invention, co-presence server 305 is configured to allow each of the members to exclude receiving such notification from a specified person or a group of persons, e.g., based on their characteristics. In such embodiments, if the caller is the person or one of the persons identified to be excluded, no message is forwarded to the identified members who wished not to receive messages from the caller. The example described above using the virtual space embodiment in connection with FIG. 4 is equally applicable to the present embodiment.

Co-presence server 305 then sends attribute information of all identified members present in the one or more virtual groups (step 711). In a preferred embodiment of the present invention, co-presence server 305 is configured to receive screening messages back from the identified members notified of the presence of the caller. For instance, one or more members of the community may not wish to allow his/her presence known to the caller, e.g., based on the caller's characteristics. In such an instance, those members may send a message to co-presence server 305 not to send any message to the caller.

The attribute information of the identified members is then forwarded to GSM 311. Co-presence server 305 can then, at the option of the caller and the identified members of the virtual groups, can make appointments to meet at a certain location (e.g., a restaurant, a conference room, etc.). In other embodiments of the present invention, co-presence server 305 is configured to establish an automatic conference call between the identified members and the caller based on the previously selected arrangements.

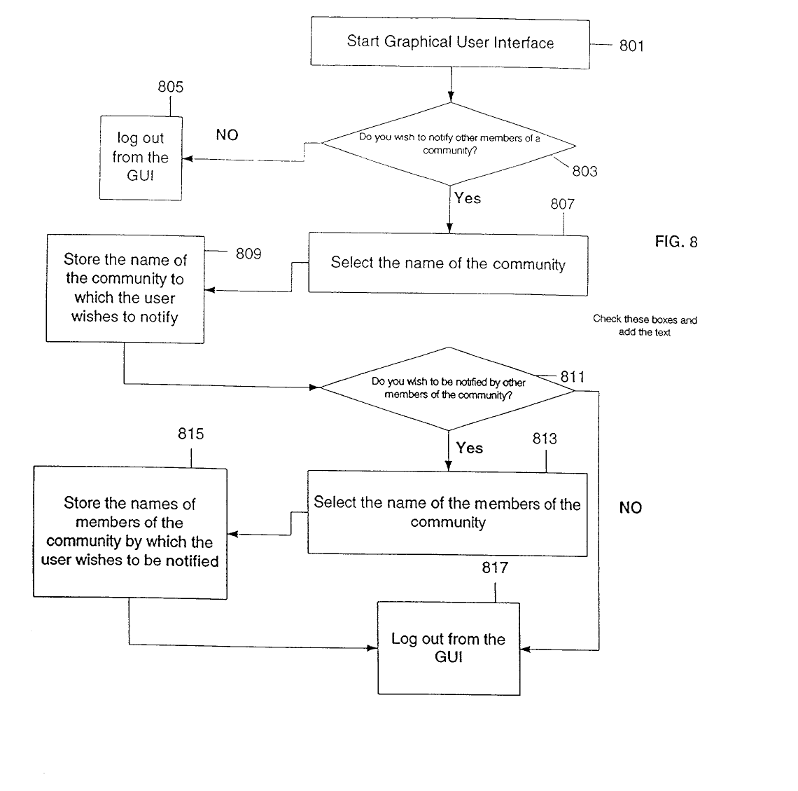

Now referring to FIG. 8, a user may enter some or all of the above described options using a co-presence options menu (e.g., a graphical user interface, GUI, 801 running on client computer 313). The menu includes an option asking the user: “Do you wish to notify other members of the community?” 803. If the answer is no, then the GUI is logged out 805. If the answer is yes, then the user is allowed to select the name of the community 807. As noted above, the user may belong to a number of different communities. In such a case, the user may select the names of more than one community. Once the user selects the name of the community, the name of the community to which the user wished to send notifications is stored in the local memory of client computer 313 and/or co-presence server 305. This information can also be stored in database 301. Subsequently, the user is then asked: “Do you wish to be notified by other members of the community?” 811. If the answer is no then the GUI is logged out. If the answer is yes then the user is requested to select the members of the community from which the user wishes to be notified from. The names of the members of the community from which the user wished to be notified are stored in the memory of its client computer 313 and/or co-presence server 305. It should be noted that the question 811 may be changed as follows: “Do you wish not to be notified by other members of the community?” In such an embodiment, the presumption is that the user would be notified by other members of the selected community unless requested otherwise. In other words, the GUI provides the following options: 1. receive or not receive notification from other members of a selected community; 2. forward or not forward notification to other members of the selected community.

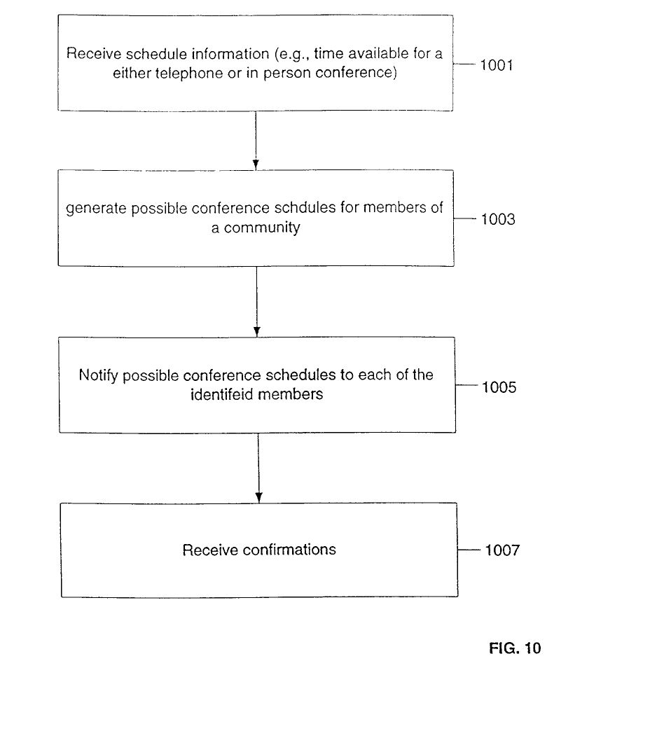

The embodiments depicted in FIGS. 4-7 are described in connection with the virtual place embodiment illustrated in FIG. 9. However, the embodiments depicted in FIGS. 4-7 can also be used in connection with the embodiment depicted in FIG. 10. In this embodiment, instead of using the virtual place, a virtual schedule is created and maintained by co-presence server 305. The embodiment depicted in FIG. 10 is referred as the virtual schedule embodiment. It should be appreciated that the virtual place embodiment and the virtual schedule embodiment may coexist and may be integrated as one tool in co-presence server 305. Alternatively, the virtual schedule embodiment may operated without the features of the virtual place embodiment. In such an embodiment, no geographical information would be required or received from the caller.

Continuing to describe the virtual schedule embodiment, co-presence server 305 may include one or more virtual schedules. A virtual schedule may be defined using various time periods, e.g., minutes, hours, days, weeks, months, etc. It should be noted that the various time periods can overlap with each other or can be mutually exclusive of each other. A virtual schedule can be created and its time period defined when a member of the community requests that a virtual schedule be create with specific time period within co-presence server 305.

Now referring back to FIG. 6 in order to illustrate the virtual schedule embodiment, a caller located at one of GSM makes a request to its telephone or network service provider in order to notify co-presence server 305. In this embodiment, the caller also sends a desired time period during which the caller may become available to have a meeting with the other members of the community that the caller belongs to. In turn, the telephone or network service provider notifies co-presence server 305 that the caller has made a phone call. It should be noted that GSM 311 may also be configured to notify co-presence server 305 directly. In another embodiment, the telephone or network service provider and GSM 311 may notify co-presence server 305 independent from each other. Regardless which device notifies co-presence server 305, the notification is accompanied by attribute information as described above in connection with FIG. 4.

In step 603, co-presence server 305 is configured to receive the attribute information and the schedule information from either the telephone or network service provider or GSM 311 (or both). Once the attribute information is received, co-presence server 305 attempts to determine if the caller belongs to its community, based upon the attribute information (in step 605). In a preferred embodiment of the present invention, one co-presence server 305 includes only one community. The above provided descriptions relating to alternative embodiments of having more than one communities and various definitions thereof and having more than one co-presence server also apply to this embodiment.

In the virtual schedule embodiment, co-presence server 305 creates one or more virtual schedules and maintains them. In step 607, co-presence server 305 determines whether or not the caller's requested time frame is within (or at least overlaps) with the time frames specified in the virtual schedules. If so, other members of the community that are listed in the virtual schedules are then identified (step 607). The identified members of the virtual schedules are notified of the caller's attribute (step 609).

Co-presence server 305 then sends attribute information of all identified members present in the one or more virtual schedules (step 611). In a preferred embodiment of the present invention, co-presence server 305 is configured to receive screening messages back from the identified members notified of the presence of the caller. For instance, one or more members of the community may not wish to allow his/her presence known to the caller. In such an instance, those members may send a message to co-presence server 305 not to send any message to the caller.

The attribute information of the identified members is then forwarded to GSM 311. Co-presence server 305 can then, at the option of the caller and the identified members of the virtual schedules, can make appointments to meet at a certain location (e.g., a restaurant, a conference room, etc.). In other embodiments of the present invention, co-presence server 305 is configured to establish an automatic conference call between the identified members and the caller based on the previously selected.

FIG. 11A depicts an exemplary cellular phone network 100 for use in accordance with the principles of the present invention. Network 100 is a wireless two-way data network that allows subscriber units such as GPS device 309, GSM device 311 and/or client computer 313 to communicate with their respective host computer 108. Subscriber units 309, 311, 313, therefore, typically have a radio frequency (RF) modem for sending and receiving signals.

Network 100 includes many base stations 110 that provides service to many localities (e.g., cities and towns). Each base station 110 may cover a radius of approximately 15-20 miles. Base stations 110 are radio frequency towers that transmit or receive radio signals between subscriber units 309, 311, 313 and the Radio Frequency/Network Control Processors (RF/NCPs) 112. Base stations 110 transmit and receive radio signals, preferably using a narrow band FM transmitter and receiver operating in the 800 MHz frequency band. There are separate frequencies for the transmit path and the receive path; together these two frequencies represent a full duplex channel that normally transmits data at 4800 bps in both directions. In operation, for a message “inbound” to the network 100 from a subscriber unit 309, 311, 313, the signal is “heard” by the base stations 110 and sent over a phone line 116 to a RF/NCP 112. The network 100 employs an automated roaming capability that allows the free movement of subscriber units 309, 311, 313 between different localities. This capability allows the subscriber units 309, 311, 313 to freely move (roam) across the country and take advantage of all the network 100 services that are available in every locale.

RF/NCPs 112 are high-speed computers that interconnect multiple base stations 110 with connectors 114 (e.g., the ARDIS® Connect Engine(s), ACEs). A number of RF/NCPs 112 are located together serving a particular geographical area, each being connected by high speed digital phone service to one of ACEs 114, which route messages to a destination such as a customer host computer 108 that is directly connected to network 100 by, for example, a leased telephone line or a value added network. RF/NCPs 112 pass information relating to source, destination and length of each message to an ACE 114 that enables the network 100 to do network analysis of traffic density in, for example, each city. An ACE 114, in turn, passes information back to an RF/NCP 112 concerning whether the subscriber unit 309, 311, 313 is properly registered to the network 100 and, if so, what level of service of provided to the respective subscriber 309, 311, 313. RF/NCPs also help manage the roaming capability of network 100. Subscriber units 309, 311, 313 can automatically move (roam) between any of the network 100 frequencies on either of the two protocols (MDC 4800 and RD-LAP 19.2), or between any of the configured network 100 layers that have been configured for in-building or on-street usage.

ACEs 114 are general purpose computers. ACEs 114 route messages to the proper destination, store subscribe registration information including entitlement, and perform accounting and billing functions. ACEs 114 also serve as a point of connectivity to customer host computers 108, perform protocol conversion, and perform network 100 troubleshooting and test functions. A plurality of ACEs 114 are interconnected through dedicated leased lines, with alternate paths available from each switch as a contingency measure against line interruptions.

Wireline network 116 provides communication between the customer host computers 108, ACEs 114, RF/NCPs 112, and base stations 110. Wireline network 116 is equipped with sophisticated communications equipment that relays customer messages. This equipment includes intelligent multiplexers, leased telephone circuits, high-speed modems or digital service units, and modems for both RF/NCP 112 and customer host computer 108 connectivity.

FIG. 11 is an illustration of the architecture of the combined Internet, POTS (plain, old, telephone service), and ADSL (asymmetric, digital, subscriber line) for use in accordance with the principles of the present invention. Furthermore, it is to be understood that the use of the Internet, ADSL, and POTS are for exemplary reasons only and that any suitable communications network may be substituted without departing from the principles of the present invention. This particular example is briefly discussed below.

In FIG. 11, to preserve POTS and to prevent a fault in the ADSL equipment 254, 256 from compromising analog voice traffic 226, 296 the voice part of the spectrum (the lowest 4 kHz) is separated from the rest by a passive filter, called a POTS splitter 258, 260. The rest of the available bandwidth—from about 10 kHz to 1 MHz—carries data at rates up to 6 bits per second for every hertz of bandwidth from data equipment 262, 264, and 294. The ADSL equipment 256 then has access to a number of destinations including significantly the Internet 220 or other data communications networks, and other destinations 270, 272.

To exploit the higher frequencies, ADSL makes use of advanced modulation techniques, of which the best known is the discrete multitone (DMT) technology. As its name implies, ADSL transmits data asymmetrically—at different rates upstream toward the central office 252 and downstream toward the subscriber 250.

Cable television providers are providing analogous Internet service to PC users over their TV cable systems by means of special cable modems. Such modems are capable of transmitting up to 30 Mb/s over hybrid fiber/coax system, which use fiber to bring signals to a neighborhood and coax to distribute it to individual subscribers.

Cable modems come in many forms. Most create a downstream data stream out of one of the 6-MHz TV channels that occupy spectrum above 50 MHz (and more likely 550 MHz) and carve an upstream channel out of the 5-50-MHz band, which is currently unused. Using 64-state quadrature amplitude modulation (64 QAM), a downstream channel can realistically transmit about 30 Mb/s (the oft-quoted lower speed of 10 Mb/s refers to PC rates associated with Ethernet connections). Upstream rates differ considerably from vendor to vendor, but good hybrid fiber/coax systems can deliver upstream speeds of a few megabits per second. Thus, like ADSL, cable modems transmit much more information downstream than upstream. Then Internet architecture 220 and ADSL architecture 254, 256 may also be combined with, for example, user networks 222, 224, and 228.

In accordance with the principles of the present invention, in one example, a main computing server implementing the process of the invention may be located on one or more computing nodes or terminals (e.g., on user networks 222, 224, and 228 or system 240). Then, various users may interface with the main server via, for instance, the ADSL equipment discussed above, and access the information and processes of the present invention from remotely located PCs. As illustrated in this embodiment, users may access or use or interact with the computer assisted program in computer system 40 via various access methods. Databases 85, 86, 87, 88, and 40 are accessible via, for example computer system 40 and may be used in conjunction with client manager module 91, tracking module 92, smart card readers 93, for the various functions described above. In another example, database 85 may contain maps, and database 86 may contain community lists.

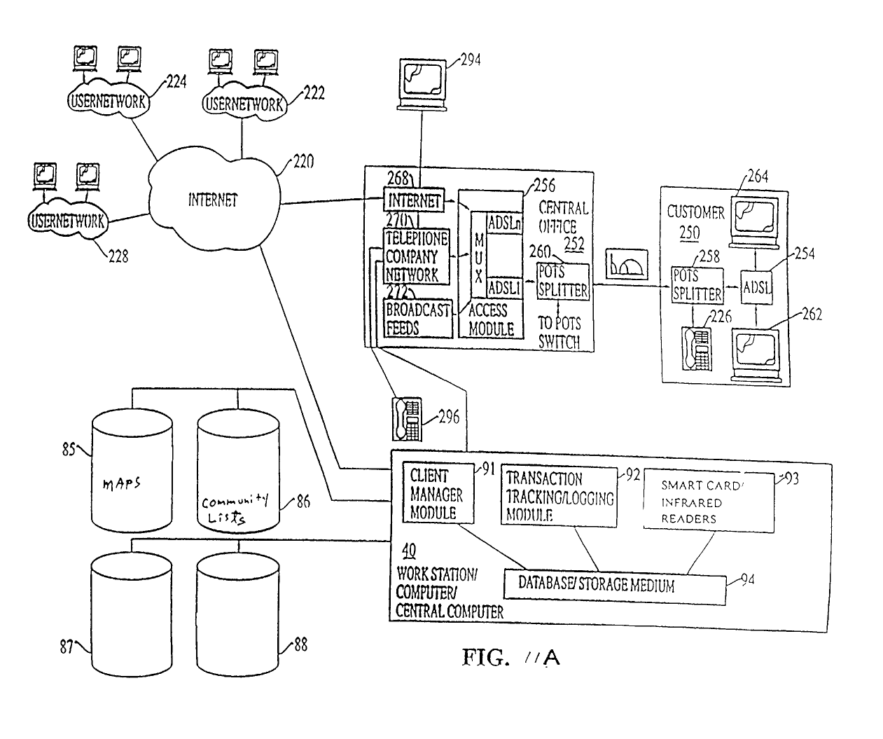

Viewed externally in FIG. 12, a computer system designated by reference numeral 1240 has a computer 1242 having disk drives 1244 and 1246. Disk drive indications 1244 and 1246 are merely symbolic of a number of disk drives which might be accommodated by the computer system. Typically, these would include a floppy disk drive 1244, a hard disk drive (not shown externally) and a CD ROM indicated by slot 1246. The number and type of drives vary, typically with different computer configurations. Disk drives 1244 and 1246 are in fact optional, and for space considerations, are easily omitted from the computer system used in conjunction with the production process/apparatus described herein.

The computer system also has an optional display upon which information screens may be displayed. In some situations, a keyboard 1250 and a mouse 1252 are provided as input devices through which a user's actions may be inputted, thus allowing input to interface with the central processing unit 1242. Then again, for enhanced portability, the keyboard 1250 is either a limited function keyboard or omitted in its entirety. In addition, mouse 1252 optionally is a touch pad control device, or a track ball device, or even omitted in its entirety as well, and similarly may be used to input a user's selections. In addition, the computer system also optionally includes at least one infrared transmitter and/or infrared received for either transmitting and/or receiving infrared signals, as described below.

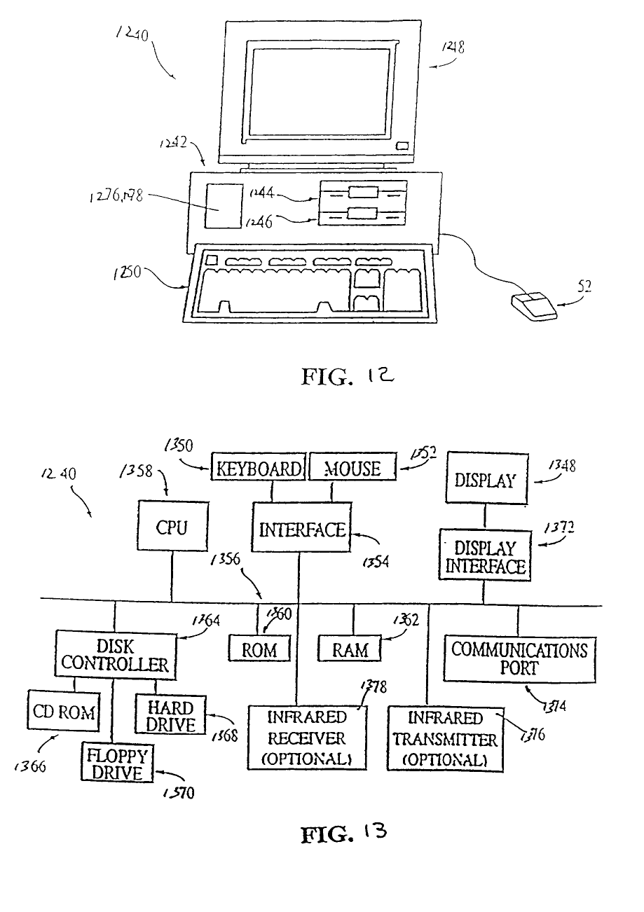

FIG. 13 illustrates a block diagram of one example of the internal hardware of a computer system 1240 that can include the task guide software component. A bus 1356 serves as the main information highway interconnecting the other components of system 1240. CPU 1358 is the central processing unit of the system, performing calculations and logic operations required to execute the processes of embodiments of the present invention as well as other programs. Read only memory (ROM) 1360 and random access memory (RAM) 1362 constitute the main memory of the system. Disk controller 1364 interfaces one or more disk drives to the system bus 1356. These disk drives are, for example, floppy disk drives 1370, or CD ROM or DVD (digital video disks) drives 1366, or internal or external hard drives 1368. These various disk drives and disk controllers are optional devices.

A display interface 1372 interfaces display 1348 and permits information from the bus 1356 to be displayed on display 1348. Display 1348 is used in displaying a graphical user interface described in connection with FIG. 8. Communications with external devices such as the other components of the system described above can occur utilizing, for example, communication port 1374. Optical fibers and/or electrical cables and/or conductors and/or optical communication (e.g., infrared, and the like) and/or wireless communication (e.g., radio frequency (RF), and the like) can be used as the transport medium between the external devices and communication port 1374. Peripheral interface 1356 interfaces the keyboard 1350 and mouse 1352, permitting input data to be transmitted to bus 1356. In addition to these components, system 1311 also optionally includes an infrared transmitter and/or infrared receiver. Infrared transmitters are optionally utilized when the computer system is used in conjunction with one or more of the processing components/stations that transmits/receives data via infrared signal transmission. Instead of utilizing an infrared transmitter or infrared receiver, the computer system may also optionally use a low power radio transmitter 1380 and/or a low power radio receiver 1382. The low power radio transmitter transmits the signal for reception by components of the production process, and receives signals from the components via the low power radio receiver. The low power radio transmitter and/or receiver are standard devices in industry.

Although system 1240 in FIG. 13 is illustrated having a single processor, a single hard disk drive and a single local memory, system 1240 is optionally suitably equipped with any multitude or combination of processors or storage devices. For example, system 1240 may be replaced by, or combined with, any suitable processing system operative in accordance with the principles of embodiments of the present invention, including sophisticated calculators, and hand-held, laptop/notebook, mini, mainframe and super computers, as well as processing system network combinations of the same.

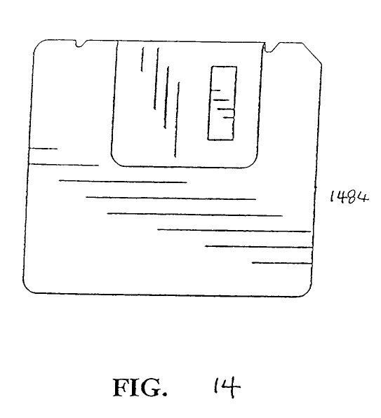

FIG. 14 is an illustration of an exemplary computer readable memory medium 1484 utilizable for storing computer readable code or instructions. As one example, medium 1484 may be used with disk drives illustrated in FIG. 13. Typically, memory media such as floppy disks, or a CD ROM, or a digital video disk will contain, for example, a multi-byte locale for a single byte language and the program information for controlling the above system to enable the computer to perform the functions described herein. Alternatively, ROM 1360 and/or RAM 1362 illustrated in FIG. 13 can also be used to store the program information that is used to instruct the central processing unit 1358 to perform the operations associated with the instant processes. Other examples of suitable computer readable media for storing information include magnetic, electronic, or optical (including holographic) storage, some combination thereof, etc. In addition, at least some embodiments of the present invention contemplate that the medium can be in the form of a transmission (e.g., digital or propagated signals).

It should be noted that the above-described features of the present invention can be combined with the features described in U.S. Pat. No. 5,819,084 issued to Shapiro et al. and U.S. Pat. No. 5,864,874 issued to Shapiro.

The many features and advantages of the invention are apparent from the detailed specification, and thus, it is intended by the appended claims to cover all such features and advantages of the invention which fall within the true spirit and scope of the invention. For instance, a caller is allowed to access co-presence server 305 through the Internet from his/her computer (e.g., client computer 313) in accordance with the notification steps describe above in connection with FIGS. 4-7. This user is also allowed to communicate with other members of virtual groups as described in FIGS. 4-7 and 9-10.

Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A means for establishing communication with a community of users defining a predetermined characteristic that users have in common, the means comprising:
a means for receiving geographical location information of a first user belonging to the community of users;
a means for determining a geographical region in which the first user is located based on the geographical location information; and
a means for finding other users from the community of users who are located within the geographical region;
a means for notifying identities of the other users found within the geographical region to the first user;
a means for notifying identity of the first user to the other users found within the geographical region;
a means for notifying identities of the first user and the other users found within the geographical region to each other; and
a means for receiving the geographical location information from a device configured to communicate its geographical location and voice/data information,
wherein the received geographical location of the first user is related to future scheduled location of the first user.

2. A method for establishing communication with a community of users defining a predetermined characteristic that users have in common, comprising the steps of:
receiving geographical location information of a first user belonging to the community of users;
determining a geographical region in which the first user is located based on the geographical location information; and
finding other users from the community of users who are located within the geographical region;
notifying identities of the other users found within the geographical region to the first user;
notifying identity of the first user to the other users found within the geographical region;
notifying identities of the first user and the other users found within the geographical region to each other; and
receiving the geographical location information from a device configured to communicate its geographical location and voice/data information,
wherein the received geographical location of the first user is related to future scheduled location of the first user. he first user.

3. A communication method comprising:
associating a co-presence server with a community of members, wherein the community defines at least one common, predetermined characteristic of the members;
creating at least one virtual group of the community; and
defining a predefined rule with which to determine whether the members belong to the at least one virtual group, wherein the predetermined rule relates to geographical locations of the members or relates to time availability of the members.

4. The method of claim 3, further comprising the steps of:
determining whether or not a first member is belongs to the at least one virtual group based on the geographical location of the first member or time availability of the first member;
identifying other members of community who also belong to the at least one virtual group; and
notifying identities of the identified members to the first member.

5. The method of claim 4, further comprising the step of:
notifying identity of the first member to the identified members.

6. The method of claim 3, further comprising the step of:
receiving the geographical locations from a device configured to communicate its geographical location and voice/data information.

7. A communication system comprising:
a means for associating a co-presence server with a community of members, wherein the community defines at least one common, predetermined characteristic of the members;
a means for creating at least one virtual group of the community; and
a means for defining a predefined rule with which to determine whether the members belong to the at least one virtual group, wherein the predetermined rule relates to geographical locations of the members or relates to time availability of the members.

8. The system of claim 7, further comprising:
a means for determining whether or not a first member is belongs to the at least one virtual group based on the geographical location of the first member or time availability of the first member;
a means for identifying other members of community who also belong to the at least one virtual group; and
a means for notifying identities of the identified members to the first member.

9. The system of claim 8, further comprising:
a means for notifying identity of the first member to the identified members.

10. The system of claim 7, further comprising:
a means for receiving the geographical locations from a device configured to communicate its geographical location and voice/data information.

11. A communication system comprising:
a data server for retrieving at least a plurality of data objects from a data repository;
means for generating one virtual place per data object retrieved from said data server and for associating each virtual place with its data object once its data object is accessed;
means for providing each virtual place with co-presence for at least two users that access the retrieved data object associated with each virtual place;
means for determining whether on not the at least two user belong to a virtual place among the virtual places based on geographical location of the at least two users; and
means responsive to said co-presence at said virtual place, for placing said at least two users that access said retrieved data object associated with said virtual place in communication with each other.

12. A data retrieval system according to claim 11 and wherein said means for generating comprises:
a co-presence server comprising at least one virtual place; and
at least two co-presence data-retrieval clients for communicating at least with said data server and with said co-presence server, each including object association means for associating a data object received from said data server with one of said at least one virtual places in said co-presence server.

13. A data retrieval system according to claim 12 and wherein said co-presence server comprises a changing plurality of place processes, one for each virtual place, and a managing process for providing communication from said co-presence data retrieval clients to said place processes.

14. A data retrieval system according to claim 12 and wherein said object association means comprises means for moving to a new virtual place.

15. A data retrieval system according to claim 11 and wherein said means for generating comprises:
a co-presence server comprising at least one virtual place which communicates with said data server; and
at least two co-presence data-retrieval clients for communicating with said co-presence server, each including object association means for associating a data object received from said co-presence server with one of said at least one virtual places in said co-presence server.

16. A data retrieval system according to claim 15 and wherein said co-presence server comprises a changing plurality of place processes, one for each virtual place, and a managing process for providing communication from said co-presence data retrieval clients to said place processes.

17. A data retrieval system according to claim 15 and wherein said object association means comprises means for moving to a new virtual place.

18. A communication system comprising:
a data server for retrieving at least a plurality of data objects from a data repository;
means for generating one communication object place per data object retrieved from said data server and for associating each communication object with its data object once its data object is accessed;
means for providing each virtual place with co-presence for at least two users that access the retrieved data object associated with each virtual place;
means for determining whether on not the at least two user belong to a virtual place among the virtual places based on geographical location of the at least two users; and
means responsive to said co-presence at said virtual place, for placing said at least two users that access said retrieved data object associated with said communication object in communication with each other.

19. A data retrieval system comprising:
a data server for retrieving at least one of a plurality of data objects from a data repository;
a co-presence server; and
at least two co-presence data-retrieval clients for communicating at least with said data server and with said co-presence server;
said co-presence server comprising:
community means for at least maintaining a list of co-presence data retrieval clients associated with a community;
at least one virtual place having a list of co-presence data-retrieval clients from said community;
means for determining whether on not the data-retrieval clients of the list belong to the at least one virtual place based on geographical location of the at least two users; and
at said virtual place at least for enabling communication among said co-presence data-retrieval clients associated therewith,
each of said co-presence data retrieval clients comprising:
object association means for associating a data object received from said data server with one of said at least one virtual places in said co-presence server; and
co-presence means, associated with said one virtual place, for associating said client with said community and for enabling communication among said co-presence data-retrieval clients associated with said one virtual place.

20. A data retrieval system according to claim 19 and wherein said community means also comprises finding means for providing a first co-presence data retrieval client of a first virtual place with a second virtual place with which a second co-presence data retrieval client is associated and communication means for providing a communication channel between said first and second virtual places to enable communication between said first and second co-presence data retrieval clients.

21. A data retrieval system according to claim 19 and wherein said co-presence server comprises a changing plurality of place processes, one for each virtual place, and a managing process for providing communication from said co-presence data retrieval clients to said place processes.

22. A data retrieval system according to claim 19 and wherein said object association means comprises means for moving to a new virtual place.
